(19) United States
(12) Patent Application Publication
(10) Pub. No.: US 2004/0174694 A1
(43) Pub. Date: Sep. 9, 2004

(54) Planar-light apparatus with a non -straight direction light module and a light-guiding plate

(76) Inventors: Wei-Hsiang Huang, Miaoli (TW); Kevin-Lin, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,789

(22) Filed: May 8, 2003

(30) Foreign Application Priority Data
Mar. 4, 2003 (TW) 92104497

(51) Int. Cl. G01D 11/28

(52) U.S. Cl. 362/31; 362/26

(57) ABSTRACT

A planar-light apparatus with a non-straight direction light module is provided. The planar-light apparatus mainly comprises a light-guiding plate and a light module. The light-guiding plate comprises a light-incident surface and a light-output surface perpendicular to the light-incident surface, and a scattering surface opposite to the light-output surface. Further, the light module connected to the light-guiding plate is used for emitting a light onto the light-incident surface, and the light module is opposite to the light-incident surface of the light-guiding plate with a certain angle of incidence. The light is incident from the light-incident surface onto the light-guiding plate with a certain angle of incidence. Therefore, the first time the light is reflected, the inclination angle of the normal of the scattering surface is reduced, so that the number of the light reflections in the light-guiding plate is also reduced. Since the light is output from the light-output surface after fewer times of reflection, the light utilization efficiency is improved.

### BACKGROUND OF INVENTION

1. Field of Invention

The present invention generally relates to a planar-light apparatus, and more particularly, to a planar-light apparatus with a non-straight direction light module.

2. Description of Related Art

Recently, thanks to the enhancement of the processing speed and data storage in the processor and computer, graphics processing performance has significantly improved, and the function of the image processing equipment, such as optical scanner, has also developed in light of the requirements of high resolution and high speed scanning. The flatbed scanner is the most popular scanner in the market now. The flatbed scanner at least comprises a scanning platform and an optical scanning module, wherein the scanning platform is, for example, a transparent glass, used for placing a document or a picture for scanning, and there is also a top cover above the scanning platform for covering it. Further, the optical scanning module comprises a light module, and when the optical scanning module is moving along with the scanning platform, the light module emits light onto the scanning platform, and the optical scanning module captures the image of the document or picture. Since the flatbed scanner is characterized in its simple structure and high expandability, besides being used for scanning general reflective-style documents or pictures, it is also used for scanning transparent documents, such as a transparency. Therefore, it has become widely accepted and used.

In order to have the general flatbed scanner support a transparent document scanning function, an external or a built-in planar-light apparatus had been widely adopted, and the light module and the optical scanning module are opposite to the document being scanned. However, the application of the planar-light apparatus is not limited to the transparent type scanner, it is also applied in the backlight module of the transmissive LCD, which is very popular now. No matter whether it is applied in the scanner or LCD, the brightness of the planar-light apparatus is always a key factor of the product quality. Therefore, how to improve the light utilization efficiency of the planar-light apparatus has become an important subject for current development.

FIG. 1 schematically shows a diagram of a conventional planar-light apparatus for scanning a transparent document. Generally, the planar-light apparatus 100 comprises a light-guiding plate 110 and a light module 120, wherein the light module 120 may be an external or a built-in top cover of the scanner 100. Further, the light module 120 mainly comprises a lamp 122 and a lamp holder 124. The lamp 122 is, for example, a fluorescent lamp used for generating a light. The lamp 122 is disposed in the lamp holder 124. Moreover, if the lamp 122 is a tube, its length is the same as the length of the lamp holder 124.

Referring to FIG. 2, it schematically shows a magnified diagram of one side of the light module and the light-guiding plate in FIG. 1. Preferably, the lamp holder 124 is, for example, an ellipse curve having an opening 126. The lamp holder 124 is used to reflect the light emitted by the lamp 122 into the light-guiding plate 110. The light-guiding plate 110 comprises a light-incident surface 112 and a light-output surface 114 perpendicular to the light-incident surface 112, and a scattering surface 116 opposite to the light-output surface 114. In the light path as shown in FIG. 2, since there is an inclination angle Î, between the light-output surface 114 and the scattering surface 116 of the light-guiding plate 110, the thickness of the light-guiding plate 110 is changed accordingly. Moreover, the opening 126 of the lamp holder 124 is faced to the light-incident surface 112 of the light-guiding plate 110, so that the light emitted by the lamp 122 is perpendicularly incident into the light-guiding plate 110 from the light-incident surface 112, and then reflected by the scattering surface 116 and output from the light-output surface 114, so as to finally form a planar light, wherein the light path of the light in the light-guiding plate 110 is a summation of distance L1 and distance L2.

To be noted, since the center of the lamp is disposed in parallel with the light-incident surface of the light-guiding plate in prior art, its inclination angle with respect to the normal Q of the scattering surface of the light-guiding plate is too large the first time the incident light is reflected. Therefore, the light has to be reflected several times before it can be output from the light-output surface of the light-guiding plate. During this period, each time when the light is reflected, the walking distance of the light is increased accordingly, and the attenuation quantity of the light brightness is also increased, so that the light cannot be effectively utilized. Therefore, not taking account of the luminous flux incident onto the light-incident surface from the lamp, and only considering the impact of the light path on the light brightness attenuation, the smaller the light path (L1+L2), the smaller attenuation of the light brightness. Therefore, under the best conditions, when the light is reflected onto the light-output surface after it is incident onto the scattering surface from the light-incident surface of the light-guiding plate, the smaller the walking distance of the light (i.e. light path L1+L2) during this period, the better the case.

### SUMMARY OF INVENTION

It is therefore the object of the present invention to provide a planar-light apparatus with a non-straight direction light module wherein the light emitted by the lamp is incident onto the light-incident surface and the scattering surface of the light-guiding plate with a certain angle of incidence, so as to achieve the object of reducing the light path and number of the light reflections in the light-guiding plate.

In order to achieve the object mentioned above, the present invention provides a planar-light apparatus with a non-straight direction light module. The planar-light apparatus mainly comprises a light-guiding plate and a light module. The light-guiding plate comprises a light-incident surface and a light-output surface perpendicular to the light-incident surface, and a scattering surface opposite to the light-output surface. Further, the light module connected to the light-guiding plate is used for emitting a light onto the light-incident surface. The light module and light-guiding plate are not on the same plane, and the light is incident onto the light-incident surface with a certain angle of incidence.

As described in the preferred embodiment according to the present invention, the light is incident onto the light-guiding plate with an incident angle of 3˜75 degrees.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a diagram of a conventional planar-light apparatus for scanning transparent documents.

FIG. 2 schematically shows a magnified diagram of one side of the light module and the light-guiding plate in FIG. 1.

FIG. 3 schematically shows a planar-light apparatus with a non-straight direction light module of a preferred embodiment according to the present invention.

FIG. 4 schematically shows a magnified diagram of one side of the light module and the light-guiding plate in FIG. 3.

FIG. 4A schematically shows a planar-light apparatus with a non-straight direction light module of a first preferred embodiment according to the present invention.

FIG. 4B schematically shows a planar-light apparatus with a non-straight direction light module of a second preferred embodiment according to the present invention.

FIG. 4C schematically shows a planar-light apparatus with a non-straight direction light module of a third preferred embodiment according to the present invention.

FIG. 5A and FIG. 5B schematically show layout diagrams of the light-incident surfaces of two types of the light-guiding plate shown in FIG. 4B and FIG. 4C.

FIG. 5C schematically shows a layout diagram of a light enhanced surface of the light-guiding plate.

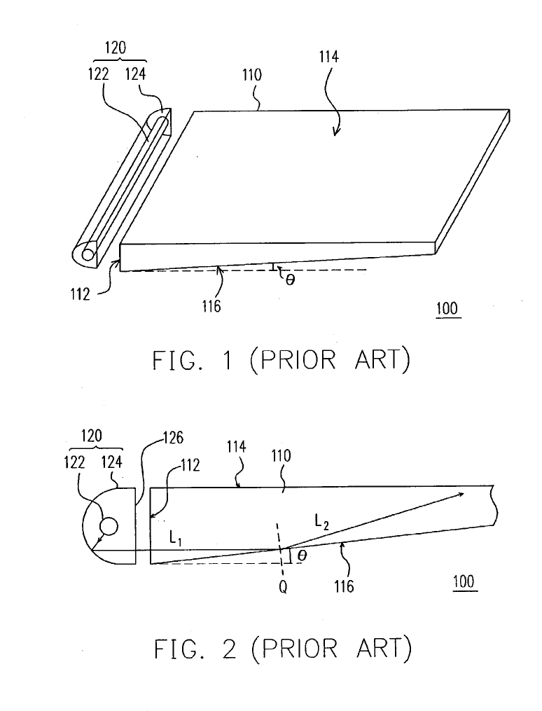

### DETAILED DESCRIPTION

FIG. 3 schematically shows a planar-light apparatus with a non-straight direction light module of a preferred embodiment according to the present invention. The transparent type scanning flatbed scanner is exemplified hereinafter. The planar-light apparatus 200 comprises a light-guiding plate 210 and a light module 220. The light module 220 may be an external or a built-in top cover of the scanner. Further, the light module 220 mainly comprises a lamp 222 and a lamp holder 224. The lamp 222 is, for example, a fluorescent lamp used for generating a light. The lamp 222 is disposed in the lamp holder 224, and its length is, for example, the same as the length of the lamp holder 224.

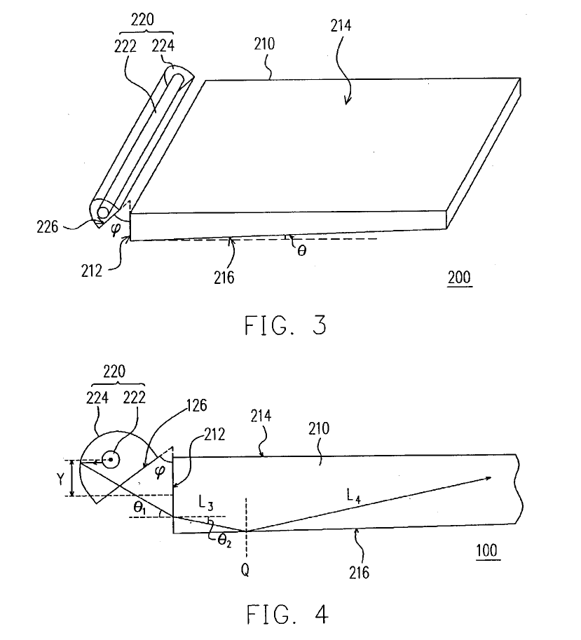

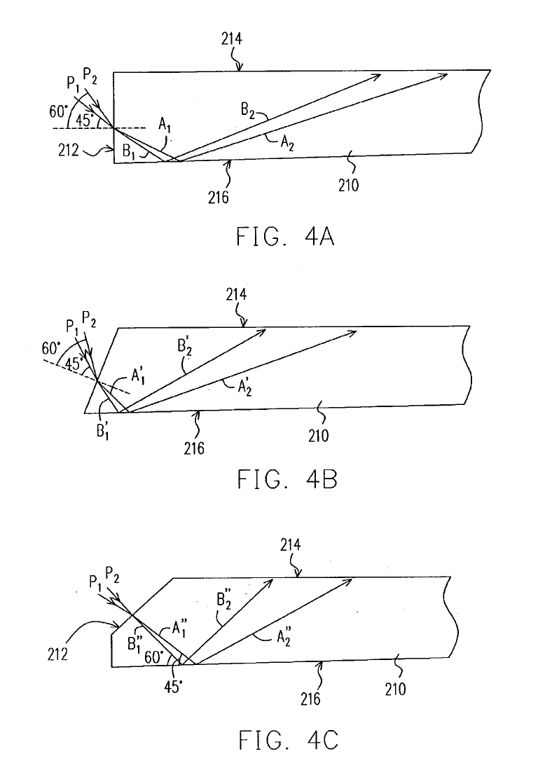

FIG. 4 schematically shows a magnified diagram of one side of the light module and the light-guiding plate in FIG. 3. Preferably, the lamp holder 224 is, for example, an ellipse curve having an opening 226. The lamp holder 224 is used to reflect the light emitted by the lamp 222 into the light-guiding plate 210. The light-guiding plate 210 comprises a light-incident surface 212 and a light-output surface 214 perpendicular to the light-incident surface 212, and a scattering surface 216 opposite to the light-output surface 214. When the light is incident onto the surface, the scattering surface 216 generates a partial diffusion effect, and the light is further diffused to the light-output surface 214, so as to achieve the brightness-equalized effect. In order to achieve the object mentioned above, it is common to perform a surface roughening or prilling operation on the scattering surface 216, so that the scattering surface 216 can have a plurality of notches or V-cuts.

Further, in the present embodiment, the light-guiding plate 210 has, for example, an inclination angle Î,, thus the distance from the scattering surface 216 to the light-output surface 214 is changed, and the thickness of the light-guiding plate 210 is different along the scattering surface 216. In the light path shown in FIG. 4, in the present embodiment, since the center of the light module 220 is opposite to the light-incident surface 212 of the light-guiding plate 210 with a shift of a perpendicular distance Y, and the opening 226 of the lamp holder 224 is opposite to the light-incident surface 212 of the light-guiding plate 210 with an inclination angle of Ï,□ the light emitted from the lamp 222 is not perpendicularly incident onto the light-incident surface 212, an instead is incident onto the light-guiding plate 210 from the light-incident surface 212 with an incident angle Î,1. The light is reflected by the scattering surface 216, and finally output from the light-output surface 214 so as to form a planar light. The light path of the light in the light-guiding plate 210 is a summation of distance L1 and distance L2, and the inclination angle of the light on the normal Q of the scattering surface 216 becomes smaller after the first time the light is reflected. Therefore, the light can be output from the light-output surface 214 without having to be reflected several times, so that the light utilization efficiency is improved.

To be noted, according to the reflection law, when the light is reflected from the loose media (e.g. air) to the dense media (e.g. glass), the reflective angle is smaller than the incident angle. For the same reason, when the light of the light module 220 is reflected from the outside air to the light-guiding plate 210, the reflective angle Î,2 is smaller than the incident angle Î,1. Certainly, the shift distance from the light module 220 to the light-incident surface 212 impacts the angle change of the incident angle Î,1 with which the light is incident onto the light-incident surface 212, and also changes the light path (L3+L4) of the light in the light-guiding plate 210. Three different embodiments are exemplified hereinafter for describing the planar-light apparatus 200 with a non-straight direction light module of the present invention. The light path change for the incident angles of 45 and 60 degrees is also compared. To be noted, when the inclination angle Î, of the light-guiding plate 210 is far smaller than the incident angle Î,1 mentioned in the present invention, the impact of the inclination angle Î, on the quantity of the light path change is far smaller than the impact of the incident angle Î,1 on the quantity of the light path change. Therefore, the impact of the inclination angle Î, on the quantity of the light path change can be neglected. Further, in the present embodiment, when the inclination angle Î, approaches to zero degree, the light is also incident onto the scattering surface 216, and then output from the light-output surface 214 so as to form a planar light.

FIG. 4A schematically shows a planar-light apparatus with a non-straight direction light module of a first preferred embodiment according to the present invention. In the first embodiment, the light-incident surface 212 of the light-guiding plate 210 is perpendicular to the light-output surface 214. The light module 220 is deployed as shown in FIG. 4, its center is opposite to the light-incident surface 212 with a shift of a perpendicular distance Y, and the opening 226 of the lamp holder 224 is opposite to the light-incident surface 212 with a certain angle of incidence. Therefore, the light generated by the lamp 222 is reflected by the lamp holder 224, and is incident onto the light-guiding plate 210 from the light-incident surface 212 with a certain incident angle. When the incident angle is 45 degrees, the light path of the light P1 in the light-guiding plate 210 is A1+A2, and when the incident angle is 60 degrees, the light path of the light P2 in the light-guiding plate 210 is B1+B2. It is known from above descriptions, different light paths can be obtained along with the change of the incident angle.

FIG. 4B schematically shows a planar-light apparatus with a non-straight direction light module of a second preferred embodiment according to the present invention. In the second embodiment, the inclination angle of the light-incident surface 212 of the light-guiding plate 210 and the light-output surface 214 is an obtuse angle (an angle greater than 90 degrees). The light module 220 is deployed as shown in FIG. 4. It is opposite to the light-incident surface 212 with a shift of a perpendicular distance, and the opening 226 of the lamp holder 224 is opposite to the light-incident surface 212 with a certain angle of incidence. Therefore, the light generated by the lamp 222 is reflected by the lamp holder 224, and is incident onto the light-guiding plate 210 from the light-incident surface 212 with a certain incident angle. When the incident angle is 45 degrees, the light path of the light P1 in the light-guiding plate 210 is A1′+A2′, and when the incident angle is 60 degrees, the light path of the light P2 in the light-guiding plate 210 is B1′+B2′. It is known from above descriptions, different light paths can be obtained along with the change of the incident angle.

FIG. 4C schematically shows a planar-light apparatus with a non-straight direction light module of a third preferred embodiment according to the present invention. In the third embodiment, the inclination angle of the light-incident surface 212 of the light-guiding plate 210 and the light-output surface 214 is an obtuse angle (an angle greater than 90 degrees), and the light-incident surface 212 is disconnected from the scattering surface 216 and is apart from it by a certain distance. The light module 220 is deployed as shown in FIG. 4. It is opposite to a plane where the light-incident surface 212 is disposed on, and the opening 226 of the lamp holder 224 is faced to the light-incident surface 212. Therefore, the light generated by the lamp 222 is reflected by the lamp holder 224 and is perpendicularly incident onto the light-incident surface 212, and also controls the angle with which the light is incident onto the scattering surface 216. When the light P1 is incident onto the scattering surface 216 with an angle of 45 degrees, the light path of the light in the light-guiding plate 210 is A1″+A2″, and when the light P2 is incident onto the scattering surface 216 with an angle of 60 degrees, the light path of the light in the light-guiding plate 210 is B1″+B2″. From above description, different light paths can be obtained along with the change of the incident angle with which the light is incident onto the scattering surface 216.

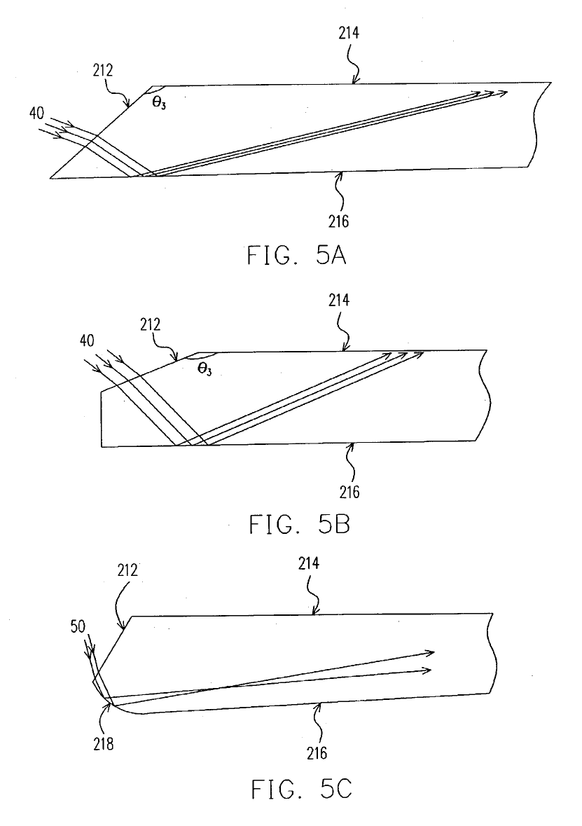

From the three embodiments mentioned above, the planar-light apparatus with a non-straight direction light module is able to reduce the light path of the light in the light-guiding plate, so as to improve the light brightness attenuation of the light-output surface and improve the light utilization efficiency. On the other hand, since the light path of most of the light is reduced, the brightness of the light emitted on the area of the light-output surface near to the lamp may be greater than the brightness of the light emitted on the area of the light-output surface far away from the lamp. In order to avoid the non-even brightness phenomenon, besides using the effect of the surface roughening on the scattering surface to achieve the object of brightness equalized, the deployed angle of the light-incident surface in the second and the third embodiment also can be used, so that partial light is incident onto one end far away from the lamp via the extended light-incident surface. FIG. 5A and FIG. 5B schematically show layout diagrams of the light-incident surfaces of the two types of the light-guiding plates shown in FIG. 4B and FIG. 4C, respectively. The light-incident surface 212 makes the light-output surface 214 extend-outbound (as shown in FIG. 5A) or extend inbound (as shown in FIG. 5B) by increasing the inclination angle Î,3 of the light-incident surface 212 and the light-output surface 214. Partial light 40 is incident onto one end of the light-output surface 214 far away from the lamp 220 via the extended light-incident surface 212, and the light 40 is output from the light-output surface 214 to increase the brightness of the light emitted on one end of the light-output surface 214 far away from the light module 220, so as to achieve a brightness-equalized effect.

Further, FIG. 5C schematically shows a layout diagram of a light enhanced surface of the light-guiding plate. One end of the light-incident surface 212 near to the scattering surface 216 forms a light enhanced surface 218, it is for example a cambered surface or a plane. Partial light 50 is incident onto one end of the scattering surface 216 far away from the light module 220 via the light enhanced surface 218, and then the light 50 is output from the light-output surface 214 to increase the brightness of the light emitted onto one end of the light-output surface 214 far away from the light module 220, so as to achieve a brightness-equalized effect.

In summary, the planar-light apparatus with a non-straight direction light module of the present invention has the following advantages: 1. The planar-light apparatus with a non-straight direction light module of the present invention uses the incident angle, with which the light is incident onto the light-guiding plate, to change the angle of the incident light opposite to the normal of the scattering surface, and shorten the distance of the light path and reduce the light brightness attenuation quantity. Therefore, the number of the light reflections in the light-guiding plate is reduced, and since the light is output from the light-output surface after passing through fewer times of reflection, the light utilization efficiency is improved. 2. The planar-light apparatus with a non-straight direction light module of the present invention uses an obtuse angle between the light-incident surface and the light-output surface of the light-guiding plate to change the angle of the incident light opposite to the normal of the scattering surface, and shorten the distance of the light path and reduce the light brightness attenuation quantity. Therefore, the number of the light reflections in the light-guiding plate is reduced, and partial light is incident onto one end of the light-output surface far away from the light module via the light enhanced surface of the light-guiding plate, so as to increase the brightness of the light emitted on one end of the light-output surface far away from the light module and to achieve a brightness-equalized effect.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A planar-light apparatus with a non-straight direction light module, at least comprising:
a light-guiding plate, comprising an light-incident surface and an light-output surface, wherein the light-guiding plate further comprises a scattering surface that is disposed on a surface opposite to the light-output surface; and
a light module, connected to the light-guiding plate and used to incident a light onto the light-incident surface, wherein there is an inclination angle between the light module and the light-incident surface of the light-guiding surface, and the light is incident onto the light-guiding plate with a certain angle of incidence, the light is then reflected by the scattering surface, and is finally output from the light-output surface.

2. The planar-light apparatus with the non-straight direction light module of claim 1, wherein the angle is between 3 degrees to 75 degrees.

3. The planar-light apparatus with the non-straight direction light module of claim 1, wherein the scattering surface comprises a plurality of notches.

4. The planar-light apparatus with the non-straight direction light module of claim 1, wherein the scattering surface comprises a plurality of V-cuts.

5. The planar-light apparatus with the non-straight direction light module of claim 1, wherein the light-incident surface of the light-guiding plate is perpendicular to the light-output surface.

6. The planar-light apparatus with the non-straight direction light module of claim 1, wherein there is an obtuse angle between the light-incident surface and the light-output surface of the light-guiding plate.

7. The planar-light apparatus with the non-straight direction light module of claim 1, wherein the light-guiding plate further comprises a light enhanced surface that is disposed on a surface between the light-incident surface and the scattering surface.

8. The planar-light apparatus with the non-straight direction light module of claim 7, wherein the light enhanced surface is one of a cambered surface or a plane.

9. The planar-light apparatus with the non-straight direction light module of claim 1, wherein the light module comprises a lamp and a lamp holder, the lamp holder is used for holding the lamp, and the lamp holder comprises an opening.

10. The planar-light apparatus with the non-straight direction light module of claim 4, wherein the lamp is a tube.

11. A light-guiding plate of claim 1, at least comprising a light-incident surface and a light-output surface, wherein the light-guiding plate further comprises a scattering surface that is disposed on a surface opposite to the light-output surface, and there is an obtuse angle between the light-incident surface and the light-output surface.

12. The light-guiding plate of claim 11, wherein the light-guiding plate further comprises a light enhanced surface that is disposed on a surface between the light-incident surface and the scattering surface.

13. The light-guiding plate of claim 12, wherein the light enhanced surface is one of a cambered surface or a plane.

14. The light-guiding plate of claim 11, wherein the scattering surface comprises a plurality of notches.

15. The light-guiding plate of claim 11, wherein the scattering surface comprises a plurality of V-cuts.
